(19) United States
(12) Patent Application Publication
(10) Pub. No.: US 2007/0001451 A1
(43) Pub. Date: Jan. 4, 2007

(54) Spring-loaded stay-tight retaining nut assembly for a tubing fitting

(76) Inventor: Kenneth C. Struven, Sunnyvale, CA (US)

Correspondence Address: Harris Zimmerman;Zimmerman & Cronen, LLP, Suite 710, 1330 Broadway, Oakland, CA, 94612, US

(21) Appl. No.: 11/477,637

(22) Filed: Jun. 28, 2006

Related U.S. Application Data
(60) Provisional application No. 60/695,560, filed on Jun. 29, 2005.

(51) Int. Cl. F16L 39/00

(52) U.S. Cl. 285/318

(57) ABSTRACT

A tubing connection provides a unique nut assembly that does not loosen or leak when exposed to the initial heat/cool cycles of a chemistry setup. The nut assembly includes a outer housing portion, and a concentric inner locking ferrule. A cavity defined between the inner and outer portion houses a stainless steel spring secured therein by a snap-engaged spring retainer. As the outer nut is rotated on the threads of the fitting, it drives the spring retainer toward the ferrule, thereby compressing the spring and causing it to maintain the engagement of the tubing end on the connector fitting.

### CROSS-REFERENCE TO RELATED APPLICATIONS

This application claims the benefit of the priority date of Provisional Application Ser. No. 60/695,560, filed Jun. 29, 2005.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to tubing connectors for chemical use and, more particularly, to tubing connectors fabricated of relatively soft polymer materials such as Teflon.

2. Description of Related Art

In chemistry laboratories, chemical processing installations, and other users of chemistry equipment, a ubiquitous component in chemical processing layouts is the common tubing connector. Most processing is conducted in a liquid-based processing scheme and whether for solvents and solutions, feedstock or waste flow, washes or etches, the instruments, pumps, reaction vessels, tanks, and valves are interconnected using inert tubing and tubing connectors. One standard arrangement for tubing connector typically has a flexible tubing with an end that is expanded elastically outwardly in diameter, in order to slidably engage the tapered end of a connector nipple. A nut is secured about the fitting and about the tubing, and is threaded onto the nipple. In installations where corrosive or poisonous fluids are used, it is commonplace to employ fittings and tubing of the most chemically inert materials, such as Teflon, fused quartz, and the like

Conventional Teflon nuts and conventional Teflon tubing tend to loosen from the rigid tubing fitting during heat/cool cycles. This tendency may be attributed to the expanded Teflon tubing relaxing or changing its flared shape in relation to the fitting on which it is placed, or creeping away from any squeezing action, a phenomenon common to Teflon and some other materials, whether through plastic flow, thermal expansion hysteresis, or the like. As this “change of shape” occurs, the nut may loosen and may typically requires additional tightening to provide the correct gripping force of the tubing on the fitting.

The main problem with the above arrangement is that at the very least the connection system becomes loose and can weep chemistry as the nut is spontaneously loosened by multiple initial hot/cold cycles. This creates an undesirable situation in which a potentially dangerous chemistry must be continually cleaned up in the area of the connection system. At the worst, if the style of the nut does not provide a locking ferrule such as that found in the latest series of FlareLok II by Entegris, the connection system can become a danger to personnel working in close proximity. The Teflon tubing changes shape or rather extrudes with heat/cool cycles, allowing it to slip out of the expanded elastic engagement with the fitting, and can become free from the fitting and nut. When this occurs, dangerous heated chemistry can be sprayed in any direction in the immediate area. Needless to say, this is not a safe event and there have been documented cases where personnel nearby required emergency medical treatment when tubing became separated from the flared tube fitting.

It should be noted that the nuts that are used in this environment have to be made of materials that are compatible with the various chemistries that will be in use. This fact is well-known, and it implies that there are not too many alternatives to choose from that will be acceptable to the end user. There is an opportunity to rectify the failings of the prior art flared tubing connection, and it is found in the design of the nut that is used with the flared tubing and fitting.

### BRIEF SUMMARY OF THE INVENTION

The present invention generally comprises a tubing connection that overcomes the drawbacks of the prior art as described above. In particular, the invention provides a unique nut assembly designed for tubing connections that does not loosen or leak when exposed to the heat/cool cycles of a chemistry setup.

The nut of the present invention provides an internal spring that stores energy to be released as needed to compensate for the changing shape of the tubing and the typical loosening of the nut. The internal spring is designed to be able to provide a pre-load force in the range of 10-79 pounds when the spring is compressed by approximately 0.100 inch. When the expanded Teflon tubing alters its shape around the tubing fitting, the spring loaded nut is able to release a percentage of its stored energy to compensate and maintain a constant force on the Teflon tubing. The result is that the tubing is continually gripped tightly, despite any flow or extrusion effect. The Teflon tube cannot change shape and extrude backwards through the nut, which would otherwise result in an un-restrained tubing end.

One advantageous aspect of the design is that the spring is disposed internally to the working parts, and it is never exposed to any of the potentially damaging chemicals that may be passing through the connection. This is accomplished by placing the spring in a cavity that is defined by sliding O-ring seals between moving parts.

The nut assembly generally comprises a main outer body portion, and a concentric inner body portion or locking ferrule. A cavity is defined between the inner and outer portions, and a stainless steel spring is secured in the cavity by a spring retainer. As the outer nut portion is rotated on the threads of the fitting, the outer nut will drive the spring retainer toward the ferrule, thereby compressing the outer end of the spring. The inner end of the spring impinges on the locking ferrule, causing it to maintain the engagement of the flared tubing end on the connector fitting, despite subtle changes in shape that may accompany heat/cool cycling of the fitting assembly.

### BRIEF DESCRIPTION OF THE DRAWING

FIG. 1 is a partial cross-sectional view of the spring-loaded nut assembly for male tubing fittings of the present invention.

FIG. 2 is an assembly view of the spring-loaded nut assembly as shown in FIG. 1.

FIG. 3 is a cross-sectional view of the spring-loaded nut assembly for a standard type of female tubing connector.

FIG. 4 is an assembly view of the spring-loaded nut assembly as shown in FIG. 3.

### DETAILED DESCRIPTION OF THE INVENTION

The present invention generally comprises a unique connector assembly having a fitting that receives a flared tubing end and secures it with a compression nut. It is intended for use in harsh chemical environments, where the presence of corrosive liquids and the potential for contamination of process chemistry necessitates the use of Teflon components. In the following description it is presumed that components are made of Teflon or an equivalent polymer material that is inert with respect to a wide range of harsh chemicals and solvents.

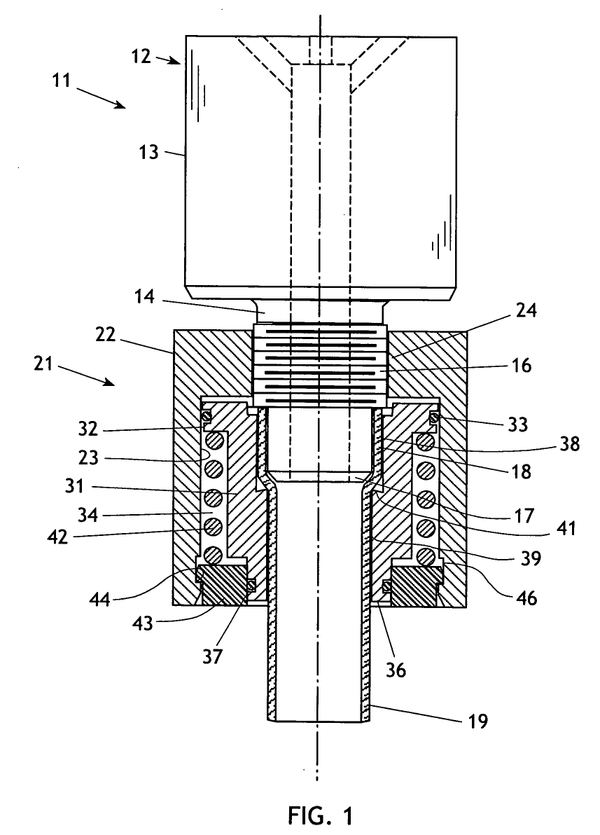

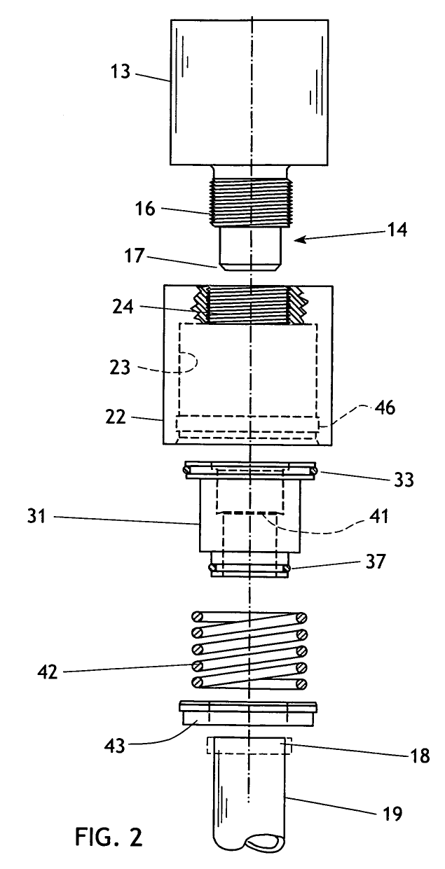

More particularly, as shown in FIGS. 1 and 2, one embodiment of the invention is designed to operate with a typical pressurized fluid (liquid or gas) connector assembly 11 having a male connector fitting 12. The fitting 12 includes a body 13, and nipple 14 extending therefrom, with external threads 16 and a tapered end 17. The end 18 of resilient tubing 19 is dimensioned to expand and slidably engage the nipple 14; this arrangement being similar to that known in the prior art.

One embodiment of the invention provides a nut assembly 21 for engaging the threads 16 and securing the tubing end 18 on the nipple 14. The nut assembly includes an outer cylindrical housing 22 having an internal bore 23, and a threaded opening 24 joining the inner end of the bore 23. The bore 23 includes a retaining groove 46 formed therein adjacent to the distal end of the housing 22. Threads 16 and 24 are complementary and mutually engaging, and opening 24 and bore 23 are concentric with tubing end 18. The exterior surface of the nut may be provided with any surface configuration (polyhedron or the like) that is engageable for turning the nut to thread and unthread from the fitting 11.

A locking ferrule 31 is dimensioned to be received concentrically and freely within the bore 23. At the proximal end, the ferrule 31 is provided with an annular shoulder 32 extending radially outwardly, with an O-ring seal 33 supported in the peripheral surface thereof. The O-ring 33 is dimensioned to establish a sliding seal with the bore 23. The outer cylindrical surface of the ferrule 31 and the bore 23 define an annular space 34. A reduced diameter neck 36 extends from the distal end of the ferrule, and is provided with an O-ring seal 37. The ferrule 31 is provided with an internal axial bore having a broader proximal end portion 38 and a narrower distal portion 39 joined by an annular step 41. Note that the diameter of proximal portion 38 is sufficient to establish a close tolerance fit with the tubing end 18 engaged on the nipple 14, and the diameter of the distal portion 39 is sufficient to receive the tubing 19 in a sliding fit. Moreover, the diameter of the portion 39 is less than the diameter of the nipple 14, so that the step 41 is driven by proximal motion of the ferrule 31 to clamp the flared portion of the tubing against the tapered end 16 of the nipple and establish a very good sealing relationship.

Within the annular space 34 a helical coil spring 42 (stainless steel or the like) is secured about the ferrule 31, with the proximal end of the spring 42 impinging on the shoulder 32. A spring retaining ring 43 has an outer flange 44 extending from a proximal portion thereof. The inner bore of the ring 43 forms a complementary fit to the neck 36, and establishes a sliding seal with O-ring 37. Flange 44 is dimensioned to engage retaining groove 46 formed in the inner bore 23 adjacent to the distal end of the bore 23. Thus the components of the nut assembly 21 may be joined by placing the ferrule 31 within the bore 23, then placing the spring 42 in the annular space 34, then inserting and snapping the retaining ring 43 into groove 46. Note that the O-ring seals 33 and 37 enclose the space 34 and protect the spring 42 from the corrosion and contamination that might otherwise occur.

In a typical installation procedure, the tubing end 18 is passed through the nut assembly 21 and pushed onto the tapered end 17 of nipple 14. The nut assembly 21 is then threaded onto the threads 16 of nipple 14, thereby translating proximally and concentrically about the flared tubing conjunction. The nut assembly advances proximally until the step 41 moves proximate to the flared end 17, and the tubing wall clamped therebetween prevents further proximal movement of the ferrule 31. Continued threaded advancement of the nut in the proximal direction will then cause the spring retainer ring 43 to move proximally against the spring 42, compressing the spring and resiliently loading the ferrule in the proximal direction, whereby the annular step 41 is resiliently biased to maintain engagement with the tapered end 17.

In a typical real-world example, the spring 42 may have sufficient stiffness to exert a compressive force of approximately 35 pounds (in the range of 10-79 pounds) after undergoing a compression of about 0.1 inch. Given the 1-20 threads used in standard fittings, this spring loading may be achieved in approximately 2 full turns of the nut assembly 21 after the ferrule 31 reaches the limit of proximal travel.

The pre-loading condition of the ferrule on the tubing conjunction assures that the step 41 maintains firm contact with the flared portion of the tubing and sustains the clamping engagement of the expanded portion. Even though the assembly may undergo movement and yielding during the thermal cycles of the connector assembly, the pre-loading condition maintains the seal and stops the leaks that would otherwise occur, e.g., with Teflon tubing. The Teflon tube cannot change shape and extrude backwards through the nut, which would otherwise result in an un-restrained tubing end.

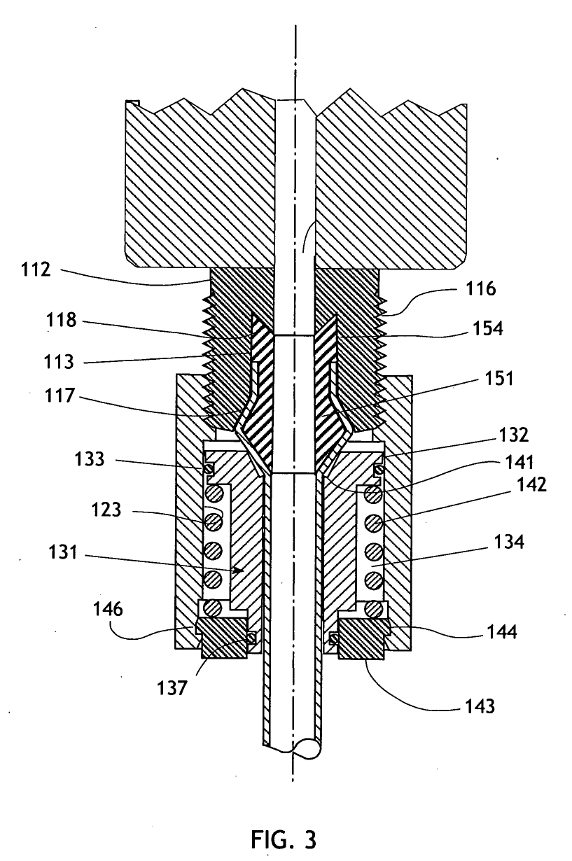

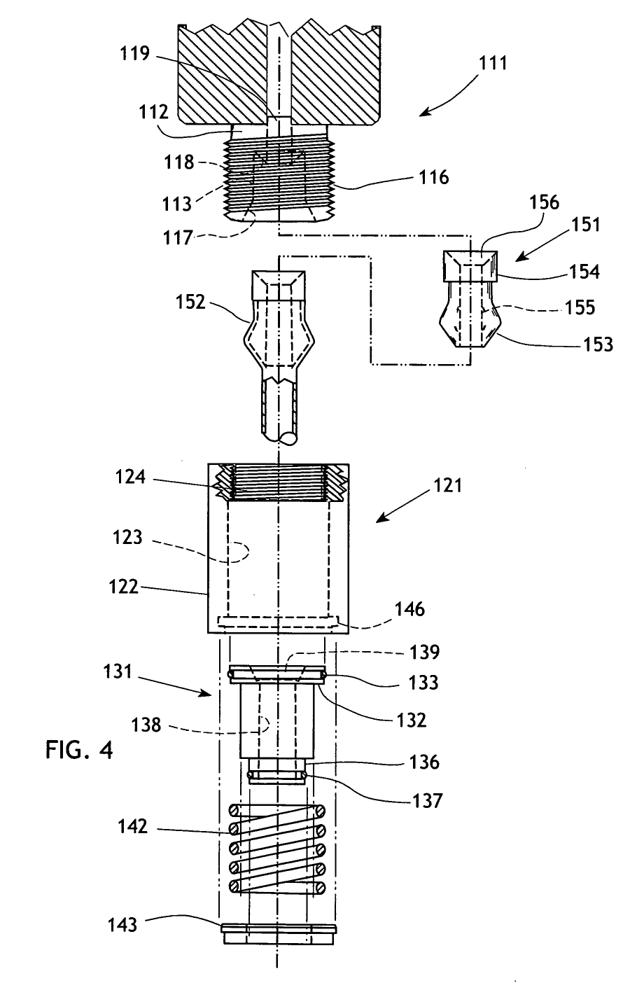

With regard to FIGS. 3 and 4, a further embodiment of the invention is adapted for use with another typical tubing connector assembly 111 having a cylindrical stem 112 extending outwardly with a female receptacle 113 formed coaxially in the outer end of the stem 112. The stem is provided with external threads 116. The receptacle 113 includes a flared outer end 117 and an inner stepped shoulder 118 that is formed as a truncated coaxial cone. and an axial flow passage 119 extending therethrough. The assembly 111 further includes a tubular insert 151 that is adapted to be introduced into the end of the tubing 152 that is intended to be secured in the assembly 111. The insert 151 includes a flared distal end 153 in an arrow shape, and a proximal flange portion 154. A flow passage 155 extends axially through the insert 151, and is provided with a beveled counterbore 156 at the proximal end thereof. The insert 151 is forcefully inserted into the end of the tubing to elastically deform the tubing about the flared end 153. The flange 154 projects radially outwardly a distance approximately equal to the thickness of the tubing, so that the flange and tubing form a generally contiguous profile that is dimensioned to be received in the receptacle 113 in close tolerance fit. These components are generally known to be used in industry-standard tubing connector designs.

Another embodiment of the invention provides a nut assembly 121 for engaging the threads 116 and securing the tubing end 152 to the nipple 112. The nut assembly 121 includes an outer cylindrical housing 122 having an internal bore 123, and a threaded opening 124 joining the inner end of the bore 123. The bore 123 includes a retaining groove 146 formed therein adjacent to the distal end of the housing 122. Threads 116 and 124 are complementary and mutually engaging, and opening 124 and bore 123 are concentric with tubing end 152. The exterior surface of the nut may be provided with any surface configuration (polyhedron or the like) that is engageable for turning the nut to thread and unthread from the stem 112.

A locking ferrule 131 is dimensioned to be received concentrically and freely within the bore 123. At the proximal end, the ferrule 131 is provided with an annular shoulder 132 extending radially outwardly, with an O-ring seal 133 supported in the peripheral surface thereof. The O-ring 133 is dimensioned to establish a sliding seal with the bore 123. The outer cylindrical surface of the ferrule 131 and the bore 123 define an annular space 134. A reduced diameter neck 136 extends from the distal end of the ferrule, and is provided with an O-ring seal 137. The ferrule 131 is provided with an internal axial bore 138 having a broader proximal beveled counterbore 139. An annular shoulder 141 projects proximally at the conjunction of the bore and counterbore, and is dimensioned and oriented to impinge on the tubing end 152 at the portion thereof that is expanded by the insert 151, in a manner that is analogous to the function of the annular step 41 of the previous embodiment. The shoulder 141 interacts with the flared surface of the insert 151 to clamp the tubing tightly therebetween and form a sealing relationship, as shown in FIG. 3.

Within the annular space 134 a helical coil spring 142 (stainless steel or the like) is secured about the ferrule 131, with the proximal end of the spring 142 impinging on the shoulder 132. A spring retaining ring 143 has an outer flange 144 extending from a proximal portion thereof. The inner bore of the ring 143 forms a complementary fit to the neck 136, and establishes a sliding seal with O-ring 137. Flange 144 is dimensioned to engage retaining groove 146 formed in the inner bore 123 adjacent to the distal end of the bore 123. Thus the components of the nut assembly 121 may be joined by placing the ferrule 131 within the bore 123, then placing the spring 142 in the annular space 134, then inserting and snapping the retaining ring 143 into groove 146. Note that the O-ring seals 133 and 137 enclose the space 134 and protect the spring 142 from the corrosion and contamination that might otherwise occur.

In a typical installation procedure, the tubing end 152 is passed through the nut assembly 121, and the insert 151 is installed in the tubing end. The nut assembly 121 is then threaded onto the threads 116 of stem 112, The nut assembly advances proximally until the shoulder 141 moves proximate to the flared end of the insert, and the tubing wall clamped therebetween prevents further proximal movement of the ferrule 131. Continued threaded advancement of the nut in the proximal direction will then cause the spring retainer ring 143 to move proximally against the spring 142, compressing the spring and resiliently loading the ferrule in the proximal direction, whereby the annular shoulder 141 is resiliently biased to maintain engagement with the tubing at the flared end of the insert 151. The resilient force directed proximally by the spring 142 also forces the expanded tubing about the insert to impinge on the complementarily formed sidewall of receptacle 113 and form a sealing relationship therewith as well. It should be noted that the beveled counterbore 156 is dimensioned to engage the truncated conical shoulder 118, so that the insert 151 is self-centering in the receptacle 113.

A broad view of the two embodiments reveals that the essential aspect of the invention is the implementation of a locking ferrule to establish a sealing relationship between a tubing end and a tubing connector, a spring to resiliently bias the locking ferrule to impinge on the tubing connector and maintain the sealing relationship, and a nut housing to enclose the spring, thread onto the fitting, and drive a spring retainer ring to compress the spring and resiliently bias the locking ferrule in the sealing direction. There are other standard tubing connection arrangements known in the prior art, and perhaps many other ways to arrange structures and components to carry out the essential invention. It is anticipated that the accompanying claims will cover all such variations.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. In a tubing connector with a stem having a distal end and a threaded portion, and a tubing having an end dimensioned to resiliently engage the distal end of the stem, an improved retaining nut assembly for securing the flared end on the connector, comprising:
an outer housing having an interior bore extending along an axis through which said tubing may extend, a proximal end of said interior bore having threads complementary to the threaded portion of the stem and engageable therewith;
locking ferrule means disposed within said outer housing and about said tubing and movable along said axis, said locking ferrule means adapted for moving proximally and engaging and clamping said tubing end to said distal end of said stem and forming and maintaining a seal therebetween;
spring means for connecting said outer housing to said locking ferrule means in force-coupling fashion to resilitlently urge said locking ferrule means proximally and maintain said seal.

2. The improved retaining nut assembly of claim 1, wherein said locking ferrule means includes a locking ferrule extending concentrically about said end of said tubing and disposed concentrically within said interior bore of said housing.

3. The improved retaining nut assembly of claim 2, further including a first O-ring seal extending about a proximal end of said locking ferrule, said first O-ring seal forming a seal with said interior bore of said outer housing.

4. The improved retaining nut assembly of claim 2, wherein said spring means includes a spring disposed about said locking ferrule and concentrically within said interior bore of said housing.

5. The improved retaining nut assembly of claim 4, further including a retaining ring disposed in a distal end of said interior bore, and snap-engaging means for securing said retaining ring in said distal end of said interior bore.

6. The improved retaining nut assembly of claim 5, wherein said snap-engaging means includes an annular groove formed in said interior bore, and a flange extending radially outwardly from said retaining ring and dimensioned to snap-engage said annular groove.

7. The improved retaining nut assembly of claim 5, wherein said spring is compressed between said retaining ring and an annular shoulder portion of said locking ferrule.

8. The improved retaining nut assembly of claim 7, further including O-ring seal means for sealing the annular space defined by the annular shoulder portion, said retaining ring, said interior bore, and the exterior surface of said locking ferrule, said annular space enclosing said spring.

9. The improved retaining nut assembly of claim 2, further including a ferrule bore extending through said ferrule for receiving said tubing therethrough, and an interior annular step in said ferrule bore.

10. The improved retaining nut assembly of claim 9, wherein said interior annular step has a diameter less than said end of said tubing, whereby proximal movement of said ferrule drives said interior annular step to impinge on said end of said tubing and effect said seal.

11. The improved retaining nut assembly of claim 3, further including a second O-ring seal extending about a distal end of said locking ferrule.

12. The improved retaining nut assembly of claim 11, further including a retaining ring secured in said interior bore, said retaining ring having an interior diameter dimensioned to receive said distal end of said locking ferrule and form a seal with said second O-ring seal.

13. The improved retaining nut assembly of claim 10, wherein said tubing end is elastically expanded about said distal end of said stem, and said annular step impinges on the expanded portion of the tubing and clamps it to the distal end of the stem.

14. The improved retaining nut assembly of claim 10, wherein said connector includes a tubular insert placed axially into said tubing end to resiliently expand said tubing end, and a receptacle extending axially into said stem, said receptacle dimensioned in complementary fashion to receive said tubing end with tubular insert in a close tolerance fit.

15. The improved retaining nut assembly of claim 14, wherein said proximal movement of said ferrule drives said interior annular step to urge said tubing end and tubing insert into said receptacle and form a seal therewith.
